(19) United States
(12) Patent Application Publication
(10) Pub. No.: US 2025/0329827 A1
(43) Pub. Date: Oct. 23, 2025

(54) METHOD FOR MANUFACTURING ALL-SOLID-STATE RECHARGEABLE BATTERY

(71) Applicant: SAMSUNG SDI CO., LTD., Yongin-si (KR)

(72) Inventors: YONG CHUL SEO, Yongin-si (KR); Joonghun KIM, Yongin-si (KR); Jikwang HA, Yongin-si (KR); Yujeong LEE, Yongin-si (KR); Jaeyeob LEE, Yongin-si (KR)

(21) Appl. No.: 18/934,353

(22) Filed: Nov. 1, 2024

(30) Foreign Application Priority Data
Apr. 17, 2024 (KR) 10-2024-0051556

(51) Int. Cl. H01M 50/103

(52) U.S. Cl. CPC H01M 50/103

(57) ABSTRACT

A method for manufacturing an all-solid-state rechargeable battery includes placing a first angular case with a concave first outer surface to face a second angular case, placing a rechargeable all-solid-state battery cell including a positive electrode, a solid electrolyte layer, a negative electrode, and at least one elastic member between the first angular case and the second angular case, and planarly deforming the first outer surface of the first angular case by engaging the first angular case and the second angular case.

### CROSS-REFERENCE TO RELATED APPLICATION

This application claims priority to and the benefit of Korean Patent Application No. 10-2024-0051556 filed in the Korean Intellectual Property Office on Apr. 17, 2024, the entire contents of which are incorporated herein by reference.

### BACKGROUND

### 1. Field

Embodiments relate to a method for manufacturing an all-solid-state rechargeable battery.

### 2. Description of the Related Art

Recently, as the risk of explosion of a battery using a liquid electrolyte has been reported, development of an all-solid-state rechargeable battery has been actively conducted. The all-solid-state rechargeable battery refers to a battery in which all materials are solid, and in particular, a battery using a solid electrolyte. The all-solid-state rechargeable battery is safe with no risk of explosion because of leakage of the electrolyte solution, is easily prepared into a thin battery, has high energy density, and is realized with large capacity, which are merits.

The above-described information disclosed in the technology behind this disclosure is only intended to improve understanding of the background of the present disclosure.

### SUMMARY

Embodiments include a method for manufacturing an all-solid-state rechargeable battery, the method including placing a first angular case with a concave first outer surface to face a second angular case, placing a rechargeable all-solid-state battery cell including a positive electrode, a solid electrolyte layer, a negative electrode, and at least one elastic member between the first angular case and the second angular case, and planarly deforming the first outer surface of the first angular case by engaging the first angular case and the second angular case.

Placing the first angular case to face the second angular case may include allowing a first inner surface of the first angular case to face a second inner surface of the second angular case and to be convex toward the second inner surface.

The first angular case may include a first bottom case, and a first sidewall case extending in a vertical direction from respective ends of the first bottom case, the second angular case includes a second bottom case, and a second sidewall case extending in the vertical direction from respective ends of the second bottom case, and a first inner surface of the first bottom case faces a second inner surface of the second bottom case.

Placing the all-solid-state battery cell between the first angular case and the second angular case may include allowing a first center region of the first inner surface to contact an upper surface of the all-solid-state battery cell.

Placing the all-solid-state battery cell between the first angular case and the second angular case may include allowing a first peripheral area surrounding the first center region from among the first inner surface to not contact the upper surface of the all-solid-state battery cell.

Planarly deforming the first outer surface of the first angular case may include engaging a first lateral engagement portion of the first sidewall case and a second lateral engagement portion of the second sidewall case.

A protrusions and depressions shape of the first lateral engagement portion may be engaged to a protrusions and depressions shape of the second lateral engagement portion.

The first lateral engagement portion and the second lateral engagement portion may be welded together.

Planarly deforming the first outer surface of the first angular case may include allowing the first inner surface of the first angular case to contact an upper surface of the all-solid-state battery cell.

Placing the first angular case to face the second angular case may include allowing the second bottom case of the second angular case to have a planar second outer surface.

Placing the first angular case to face the second angular case may include allowing the second bottom case of the second angular case to have a concave second outer surface.

Placing the first angular case to face the second angular case may include allowing a second inner surface of the second bottom case to face the first inner surface of the first bottom case and to be convex toward the first inner surface.

Placing the all-solid-state battery cell between the first angular case and the second angular case may include allowing a second center region of the second inner surface to contact a bottom surface of the all-solid-state battery cell.

Placing the all-solid-state battery cell between the first angular case and the second angular case may include allowing a second peripheral area surrounding the second center region from among the second inner surface to not contact the bottom surface of the all-solid-state battery cell.

Planarly deforming the first outer surface of the first bottom case may include planarly deforming the second outer surface of the second bottom case.

Planarly deforming the second outer surface of the second bottom case may include allowing the second inner surface of the second bottom case to contact the bottom surface of the all-solid-state battery cell.

### BRIEF DESCRIPTION OF THE DRAWINGS

Features will become apparent to those of ordinary skill in the art by describing in detail exemplary embodiments with reference to the attached drawings, in which:

FIG. 1 is a cross-sectional view of an all-solid-state battery, according to one or more embodiments;

FIG. 2 is a cross-sectional view of an all-solid-state battery including a precipitation-type negative electrode, according to one or more embodiments;

FIG. 3 is a flowchart of a method for manufacturing an all-solid-state rechargeable battery, according to one or more embodiments;

FIG. 4 is a perspective view on a first stage of a method for manufacturing an all-solid-state rechargeable battery, according to one or more embodiments;

FIG. 5 is a cross-sectional view with respect to a line V-V′ of FIG. 4;

FIG. 6 to FIG. 8 show cross-sectional views on next stages of FIG. 5, according to one or more embodiments;

FIG. 9 is a flowchart of a method for manufacturing an all-solid-state rechargeable battery, according to one or more embodiments;

FIG. 10 is a perspective view on a first stage of a method for manufacturing an all-solid-state rechargeable battery, according to one or more embodiments;

FIG. 11 is a cross-sectional view with respect to a line XI-XI′ of FIG. 10 according to one or more embodiments; and

FIG. 12 to FIG. 14 show cross-sectional views on next stages of FIG. 11 according to one or more embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The present disclosure will be described more fully hereinafter with reference to the accompanying drawings, in which embodiments of the disclosure are shown. As those of ordinary skill in the art would realize, the described embodiments may be modified in various different ways, all without departing from the spirit or scope of the present disclosure.

Unless explicitly described to the contrary, the word “comprise”, and variations such as “comprises” or “comprising”, as well as “including” will be understood to imply the inclusion of stated elements but not the exclusion of any other elements.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

The term “layer” herein includes not only a shape formed on the whole surface when viewed from a plan view, but also a shape formed on a partial surface. The term “or” is not to be construed as an exclusive meaning, for example, “A or B” is construed to include A, B, A+B, and the like.

Positive electrode for all-solid-state rechargeable battery

One or more embodiments provide a positive electrode for an all-solid-state rechargeable battery including a current collector and a positive active material layer disposed or placed on the current collector, and the positive active material layer may include at least one of a positive active material, a sulfide-based solid electrolyte, a binder, and a conductive material.

Without being limited thereto, the positive electrode for an all-solid-state rechargeable battery may include a greater or less number of components than the above-noted components.

In one or more embodiments, the positive electrode for an all-solid-state rechargeable battery may be manufactured by applying a positive electrode composition including at least one of a positive active material, a sulfide-based solid electrolyte, a binder, and a conductive material to the current collector, drying then, and rolling them.

### Positive Active Material

The positive active material may include any of various positive active materials generally used with all-solid-state rechargeable batteries. For example, the positive active material may be a compound allowing reversible intercalation and deintercalation of lithium, and may include a compound expressed as one of following formulae.

$${Li}_{a} {A}_{1 - b} {X}_{b} {D}_{2} ( 0.90 \leq a \leq 1.8 , 0 \leq b \leq 0 \text{.5} ) ;$$

$${Li}_{a} {A}_{1 - b} {X}_{b} {O}_{2 - c} {D}_{c} ( 0.90 \leq a \leq 1.8 , 0 \leq b \leq 0.5 , 0 \leq c \leq 0.05 ) ;$$

$${Li}_{a} {E}_{1 - b} {X}_{b} {O}_{2 - c} {D}_{c} ( 0.90 \leq a \leq 1.8 , 0 \leq b \leq 0.5 , 0 \leq c \leq 0.05 ) ;$$

$${Li}_{a} {E}_{2 - b} {X}_{b} {O}_{4 - c} {D}_{c} ( 0.90 \leq a \leq 1.8 , 0 \leq b \leq 0.5 , 0 \leq c \leq 0.05 ) ;$$

$${Li}_{a} {Ni}_{1 - b - c} {Co}_{b} {X}_{c} {D}_{α} ( 0.90 \leq a \leq 1.8 , 0 \leq b \leq 0.5 , 0 \leq c \leq 0.5 , 0 < α \leq 2 ) ;$$

$${Li}_{a} {Ni}_{1 - b - c} {Co}_{b} {X}_{c} {O}_{2 - α} {T}_{α} ( 0.90 \leq a \leq 1.8 , 0 \leq b \leq 0.5 , 0 \leq c \leq 0.05 , 0 < α < 2 ) ;$$

$${Li}_{a} {Ni}_{1 - b - c} {Co}_{b} {X}_{c} {O}_{2 - α} {T}_{2} ( 0.90 \leq a \leq 1.8 , 0 \leq b \leq 0.5 , 0 \leq c \leq 0.05 , 0 < α < 2 ) ;$$

$${Li}_{a} {Ni}_{1 - b - c} {Mn}_{b} {X}_{c} {D}_{α} ( 0.90 \leq a \leq 1.8 , 0 \leq b \leq 0.5 , 0 \leq c \leq 0.05 , 0 < α \leq 2 ) ;$$

$${Li}_{a} {Ni}_{1 - b - c} {Mn}_{b} {X}_{c} {O}_{2 - α} {T}_{α} ( 0.90 \leq a \leq 1.8 , 0 \leq b \leq 0.5 , 0 \leq c \leq 0.05 , 0 < α < 2 ) ;$$

$${Li}_{a} {Ni}_{1 - b - c} {Mn}_{b} {X}_{c} {O}_{2 - α} {T}_{2} ( 0.90 \leq a \leq 1.8 , 0 \leq b \leq 0.5 , 0 \leq c \leq 0.05 , 0 < α < 2 ) ;$$

$${Li}_{a} {Ni}_{b} {E}_{c} {G}_{d} {O}_{2} ( 0.90 \leq a \leq 1.8 , 0 \leq b \leq 0.9 , 0 \leq c \leq 0.5 , 0.001 \leq d \leq 0 \text{.1} ) ;$$

$${Li}_{a} {Ni}_{b} {Co}_{c} {Mn}_{d} {G}_{e} {O}_{2} ( 0.90 \leq a \leq 1.8 , 0 \leq b \leq 0.9 , 0 \leq c \leq 0.5 , 0 \leq d \leq 0.5 , 0.001 \leq e \leq 0 \text{.1} ) ;$$

$${Li}_{a} {NiG}_{b} {O}_{2} ( 0.90 \leq a \leq 1.8 , 0.001 \leq b \leq 0 \text{.1} ) ;$$

$${Li}_{a} {CoG}_{b} {O}_{2} ( 0.90 \leq a \leq 1.8 , 0.001 \leq b \leq 0 \text{.1} ) ;$$

$${Li}_{a} {Mn}_{1 - b} {G}_{b} {O}_{2} ( 0.90 \leq a \leq 1.8 , 0.001 \leq b \leq 0 \text{.1} ) ;$$

$${Li}_{a} {Mn}_{2} {G}_{b} {O}_{4} ( 0.90 \leq a \leq 1.8 , 0.001 \leq b \leq 0 \text{.1} ) ;$$

$${Li}_{a} {Mn}_{1 - g} {G}_{g} {PO}_{4} ( 0.90 \leq a \leq 1.8 , 0 \leq g \leq 0 \text{.5} ) ;$$

$${QO}_{2} ; {QS}_{2} ; {LiQS}_{2} ;$$

$${V}_{2} {O}_{5} ; {LiV}_{2} {O}_{5} ;$$

$${LiZO}_{2} ;$$

$${LiNiVO}_{4} ;$$

$${Li}_{( 3 - f )} {{J}_{2} ( {PO}_{4} )}_{3} ( 0 \leq f \leq 2 ) ;$$

$${Li}_{( 3 - f )} {{Fe}_{2} ( {PO}_{4} )}_{3} ( 0 \leq f \leq 2 ) ;$$

$${Li}_{a} {FePO}_{4} ( 0.90 \leq a \leq 1.8 ) .$$

Regarding the formulae, A may be selected from among Ni, Co, Mn, and combinations thereof; X may be selected from Al, Ni, Co, Mn, Cr, Fe, Mg, Sr, V, rare earth elements, and combinations thereof; D may be selected from among O, F, S, P, and combinations thereof; E may be selected from among Co, Mn, and combinations thereof; T may be selected from among F, S, P, and combinations thereof; G may be selected from among Al, Cr, Mn, Fe, Mg, La, Ce, Sr, V, and combinations thereof; Q may be selected from among Ti, Mo, Mn, and combinations thereof; Z may be selected from among Cr, V, Fe, Sc, Y, and combinations thereof; and J may be selected from among V, Cr, Mn, Co, Ni, Cu, and combinations thereof.

The positive active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or a lithium iron phosphate oxide (LFP).

The positive active material may include a lithium nickel-based oxide expressed in Formula 1, a lithium cobalt-based oxide expressed in Formula 2, a lithium iron phosphate-based compound expressed in Formula 3, or combinations thereof.

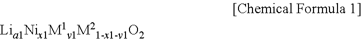

In Chemical Formula 1, it may be given that 0.9≤a1≤1.8, 0.3≤x1≤1, 0≤y1≤0.7, and M1 and M2 may be at least one element independently selected from among Al, B, Ba, Ca, Ce, Co, Cr, Cu, F, Fe, Mg, Mn, Mo, Nb, P, S, Si, Sr, Ti, V, W, and Zr.

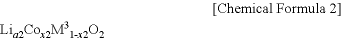

In Chemical Formula 2, it may be given that 0.9≤a2≤1.8, 0.6≤x2≤1, and M3 is at least one element selected from among Al, B, Ba, Ca, Ce, Cr, Cu, F, Fe, Mg, Mn, Mo, Nb, P, S, Si, Sr, Ti, V, W, and Zr.

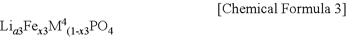

In Chemical Formula 3, it may be given that 0.9≤a3≤1.8, 0.6≤x3≤1, and M4 is at least one element selected from among Al, B, Ba, Ca, Ce, Co, Cr, Cu, F, Fe, Mg, Mn, Mo, Nb, P, S, Si, Sr, Ti, V, W, and Zr.

An average particle diameter D₅₀ of the positive active material may be 1 μm to 25 μm, for example, 3 μm to 25 μm, 5 μm to 25 μm, 5 μm to 20 μm, 8 μm to 20 μm, or 10 μm to 18 μm. The positive active material having the particle diameter range may be mixed with other components in the positive active material layer and may realize high capacity and high energy density.

The positive active material may include a secondary particle form made by agglomerating primary particles or may have a single particle form. The positive active material may have a spherical shape or another shape that is similar to the spherical shape, or may be a polyhedron or atypical.

### Sulfide-Based Solid Electrolyte

The sulfide-based solid electrolyte may include, for example, Li₂S—P₂S₅, Li₂S—P₂S₅—LiX(X is a halogen element, for example, I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are integers, and Z is Ge, Zn or Ga), Li₂S—GeS₂, Li₂S—SiS₂—Li₃PO₄, Li₂S—SiS₂-LiₚMO_{q} (p and q are integers, and M is P, Si, Ge, B, Al, Ga or In), or combinations thereof.

The sulfide-based solid electrolyte may be obtained by, for example, mixing Li₂S and P₂S₅ with a mole ratio of 50:50 to 90:10 or the mole ratio of 50:50 to 80:20, and selectively performing a heat treatment. Within the mixed ratio range, the sulfide-based solid electrolyte with excellent ion conductivity may be prepared. The ion conductivity may be further increased by including other components such as SiS₂, GeS₂, or B₂S₃.

A mechanical milling or a solution method may be applied as a method for mixing sulfur-containing materials and producing a sulfide-based solid electrolyte. The mechanical milling may be a method for inserting start materials and a ball mill into a reactor and strongly agitating them to particulate the start materials and mix them. If using the solution method, the solid electrolyte may be obtained as a precipitate by mixing the starting materials in a solvent. If heat treatment is performed after mixing, the solid electrolyte crystals may become more solid and the ion conductivity may be improved. For example, the sulfide-based solid electrolyte may be prepared by mixing sulfur-containing materials and heat treating them at least twice, and in this case, the sulfide-based solid electrolyte with high ion conductivity and robustness may be prepared.

For example, the sulfide-based solid electrolyte particle may include an argyrodite-type sulfide. The argyrodite-type sulfide may be expressed by, for example, the formula of LiₐM_{b}P_{c}S_{d}Aₑ (a, b, c, d and e are equal to or greater than 0 and equal to or less than 12, M is a metal exclusive of Li or combination of metals exclusive of Li, and A is F, Cl, Br, or I), and may be expressed by the formula of Li₇₋ₓPS₆₋ₓAₓ (x is equal to or greater than 0.2 and equal to or less than 1.8, and A is F, Cl, Br, or I). The argyrodite-type sulfide may be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, etc.

The sulfide-based solid electrolyte particles including the argyrodite-type sulfide may have high ion conductivity that is close to the range of 10⁻⁴ to 10⁻² S/cm, which is the ion conductivity of the general liquid electrolytes at the room temperature, and may form an intimate bond between the positive active material and the solid electrolyte without causing a decrease in the ion conductivity, and may furthermore form an intimate interface between an electrode layer and a solid electrolyte layer. The all-solid-state battery including the same may have improved battery performance such as rate capability, coulombic efficiency, and cycle-life characteristics.

The argyrodite-type sulfide-based solid electrolyte may be prepared, for example, by mixing lithium sulfide and phosphorus sulfide, and optionally lithium halide. A heat treatment may be performed after mixing them. The heat treatment may include, for example, at least two heat treatment stages.

The average particle diameter D₅₀ of the sulfide-based solid electrolyte particle according to an embodiment may be equal to or less than 5.0 μm, for example, 0.1 μm to 5.0 μm, 0.1 μm to 4.0 μm, 0.1 μm to 3.0 μm, 0.5 μm to 2.0 μm, or 0.1 μm to 1.5 μm. The sulfide-based solid electrolyte particles may be small particles with the average particle diameter D50 of 0.1 μm to 1.0 μm or large particles with the average particle diameter D50 of 1.5 μm to 5.0 μm depending on used positions or purposes. The sulfide-based solid electrolyte particles having this particle size range may effectively penetrate among the solid particles in the battery, and may have excellent contact with the electrode active material and connectivity among the solid electrolyte particles. The average particle diameter of the sulfide-based solid electrolyte particles may be measured using a microscope image, and for example, a particle size distribution may be obtained by measuring the size of about twenty particles in a scanning electron microscope image, and calculating the diameter D₅₀ therefrom.

A content of the solid electrolyte in the positive electrode for an all-solid-state rechargeable battery may be 0.5 wt % to 35 wt %, for example, 1 wt % to 35 wt %, 5 wt % to 30 wt %, 8 wt % to 25 wt %, or 10 wt % to 20 wt %. This may be the content for the entire weight of the components in the positive electrode, and in some embodiments, may be the content for the entire weight of the positive active material layer.

In an embodiment, the positive active material layer may include 50 wt % to 99.35 wt % of the positive active material, 0.5 wt % to 35 wt % of the sulfide-based solid electrolyte, 0.1 wt % to 10 wt % of the fluorinated resin binder, and 0.05 wt % to 5 wt % of the vanadium oxide based on 100 wt % of the positive active material layer. When the above-noted content range is satisfied, the positive electrode for an all-solid-state rechargeable battery may realize high capacity and high ion conductivity, may maintain high adherence, and may maintain the viscosity of the positive electrode composition at an appropriate level, thereby improving processability.

### Binder

The binder may attach the positive active material particles to each other, and may attach the positive active material to the substrate that is a current collector, and for example, the binder may use polyvinylalcohol, carboxylmethylcellulose, hydroxypropylcellulose, deacetylcellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, and nylon, but is not limited thereto.

### Conductive Material

The positive active material layer may further include a conductive material. The conductive material may provide conductivity to the electrode, for example, it may include carbon-based materials such as natural graphite, artificial graphite, carbon black, acetylene black, Ketjen black, carbon fibers, carbon nanotubes, etc.; metal-based materials containing copper, nickel, aluminum, and silver and having a metal powder form or a metal fiber form; conductive polymers such as polyphenylene derivatives; or combinations thereof.

The conductive material may be included in an amount of 0.1 wt % to 5 wt %, or 0.1 wt % to 3 wt % based on the entire weight of the respective components of the positive electrode for an all-solid-state battery or the entire weight of the positive active material layer. Within the content range, the conductive material may not deteriorate the battery performance but may improve the electrical conductivity.

When the positive active material layer further includes a conductive material, the positive active material layer may include 45 wt % to 99.25 wt % of the positive active material, 0.5 wt % to 35 wt % of the sulfide-based solid electrolyte, 0.1 wt % to 10 wt % of the fluorinated resin binder, 0.05 wt % to 5 wt % of the vanadium oxide, and 0.1 wt % to 5 wt % of the conductive material based on 100 wt % of the positive active material layer.

The positive electrode for a lithium rechargeable battery may further include an oxide-based inorganic solid electrolyte in addition to the above-described solid electrolyte. The oxide-based inorganic solid electrolyte may include, for example, Li₁₊ₓTi₂₋ₓAl(PO₄)₃(LTAP)(0≤x<4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb_{1—x}LaₓZr_{1-y}Ti_{y}O₃ (PLZT) (0≤x<1, 0≤y<1), PB(Mg₃Nb_{2/3}) O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂(0≤x≤1, 0≤y≤1), lithium lanthanum titanate (LiₓLa_{y}TiO₃, 0<x<2, 0<y<3), LizO, LiAlO₂, Li₂O—Al₂O₃—SiO₂—P₂O₅—TiO₂—GeO₂-based ceramics, Garnet-based ceramics Li₃₊ₓLa₃M₂O₁₂ (M=Te, Nb, or Zr; x is an integer of 1 to 10), or combinations thereof.

### All-Solid-State Rechargeable Battery

The embodiment may provide the all-solid-state rechargeable battery including the above-described positive electrode and the negative electrode and the solid electrolyte layer disposed or placed between the positive electrode and the negative electrode. The all-solid-state rechargeable battery may be expressed as an all-solid-state battery, or an all-solid-state lithium rechargeable battery.

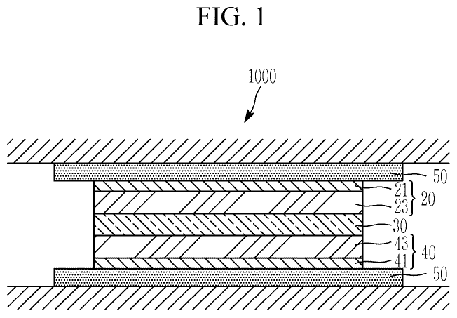

FIG. 1 is a cross-sectional view of an all-solid-state battery according to one or more embodiments.

Referring to FIG. 1, the all-solid-state battery 1000 may have a structure in which an electrode assembly, including a negative electrode 40 including a negative electrode current collecting layer 41 and a negative active material layer 43, a solid electrolyte layer 30, and a positive electrode 20 including a positive active material layer 23 and a positive electrode current collector 21 are stacked, is received in a case such as a pouch. The all-solid-state battery 1000 may further include an elastic layer 50 on at least one external side of the positive electrode 20 and the negative electrode 40. FIG. 1 shows one electrode assembly including the negative electrode 40, the solid electrolyte layer 30, and the positive electrode 20, and the all-solid-state battery may be manufactured by stacking at least two electrode assemblies.

### Negative Electrode

The negative electrode for an all-solid-state battery may, for example, include a current collector and a negative active material layer disposed or placed on the current collector. The negative active material layer may include a negative active material, and may further include a binder, a conductive material, and/or a solid electrolyte.

The negative active material may include a material for reversibly intercalating/deintercalating lithium ions, a lithium metal, alloys of the lithium metal, a material doped to the lithium and dedoped from the same, or a transition metal oxide.

The material for reversibly intercalating/deintercalating lithium ions may include, for example crystalline carbon, amorphous carbon, or a combination thereof as a carbon-based negative active material. The crystalline carbon may be non-shaped, or sheet, flake, spherical, or fiber shaped natural graphite or artificial graphite, and the amorphous carbon may be a soft carbon, a hard carbon, a mesophase pitch carbonized product, calcined coke, and the like.

The alloy of the lithium metal may use an alloy of lithium and at least one metal of Na, K, Rb, Cs, Fr, Be, Mg, Ca, Sr, Si, Sb, Pb, In, Zn, Ba, Ra, Ge, Al and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn), and at least one of these materials may be mixed with SiO₂. The elements Q and R may be selected from among Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and combinations thereof.

The silicon-carbon composite may be, for example, a silicon-carbon composite including a core, the core including crystalline carbon and silicon particles and an amorphous carbon coating layer disposed or placed on the surface of the core. The crystalline carbon may be artificial graphite, natural graphite, or combinations thereof. The amorphous carbon precursor may be coal-based pitch, mesophase pitch, petroleum-based pitch, coal-based oil, petroleum-based heavy oil, or a polymer resin such as a phenol resin, a furan resin, or a polyimide resin. The content of silicon may be 10 wt % to 50 wt % of a total weight of the silicon-carbon composite. The content of the crystalline carbon may be 10 wt % to 70 wt % of the total weight of the silicon-carbon composite, and the content of the amorphous carbon may be 20 wt % to 40 wt % of the total weight of the silicon-carbon composite. A thickness of the amorphous carbon coating layer may be 5 nm to 100 nm.

The average particle diameter D₅₀ of the silicon particle may be 10 nm to 20 μm, for example, 10 nm to 500 nm. The silicon particles may exist in an oxidized form, and an atomic content ratio of Si:O in the silicon particles indicating a degree of oxidation may be 99:1 to 33:67. The silicon particle may be particles of SiOₓ, and the range of x in SiOₓ may be greater than 0 and less than 2. The average particle diameter D₅₀ may be measured with a particle size analyzer using a laser diffraction method and may represent a diameter of the particles whose cumulative volume is 50 volume % in a particle size distribution, based on total volume.

The Si-based negative active material or the Sn-based negative active material may be mixed with the carbon-based negative active material. A mixing ratio of the carbon-based negative active material with one of the Si-based negative active material and the Sn-based negative active material may be 1:99 to 90:10 as the weight ratio.

The content of the negative active material on the negative active material layer may be 95 wt % to 99 wt % of the total weight of the negative active material layer.

In one or more embodiments, the negative active material layer may further include a binder, and may optionally further include a conductive material. The content of the binder on the negative active material layer may be 1 wt % to 5 wt % of the entire weight of the negative active material layer. If further including the conductive material, the negative active material layer may include 90 wt % to 98 wt % of the negative active material, 1 wt % to 5 wt % of the binder, and 1 wt % to 5 wt % of the conductive material.

The binder may adhere the negative active material particles to each other and may also adhere the negative active material to the current collector. The binder may include a non-water-soluble binder, a water-soluble binder, or a combination thereof.

The non-water-soluble binder may include, for example, polyvinylchloride, carboxylated polyvinylchloride, polyvinylfluoride, ethylene oxide-containing polymer, ethylene propylene copolymer, polystyrene, polyvinylpyrrolidone, polyurethane, polytetrafluoroethylene, polyvinylidene fluoride, polyethylene, polypropylene, polyamide-imide, polyimide, or combinations thereof.

The water-soluble binder may include a rubber-based binder or a polymer resin binder. The rubber-based binder may be selected from among a styrene-butadiene rubber, an acrylated styrene-butadiene rubber, an acrylonitrile-butadiene rubber, an acrylic rubber, a butyl rubber, a fluoro rubber, and combinations thereof. The polymer resin binder may be selected from among a polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and combinations thereof.

If the water-soluble binder is used as the negative electrode binder, a thickener for providing viscosity may be used together, and the thickener may include, for example, a cellulose-based compound. The cellulose-based compound may include carboxymethyl cellulose, hydroxypropylmethyl cellulose, methyl cellulose, alkali metal salts thereof, or combinations thereof. Na, K, or Li may be used as the alkali metal. The used amount of the thickener may be 0.1 parts by weight to 3 parts by weight based on 100 parts by weight of the negative active material.

The conductive material may be used to provide conductivity to the electrode, and may include, for example, carbon-based materials such as natural graphite, artificial graphite, carbon black, acetylene black, ketjen black, carbon fibers, or carbon nanotubes; metal materials including copper, nickel, aluminum, and silver and having a metal powder shape or a metal fiber shape; conductive polymers such as a polyphenylene derivative; or mixtures thereof.

The negative current collector may include one selected from a copper foil, a nickel foil, a stainless-steel foil, a titanium foil, a nickel foam, a copper foam, a polymer substrate coated with a conductive metal, and combinations thereof.

As another example, the negative electrode for an all-solid-state battery may be a precipitation-type negative electrode. The precipitation-type negative electrode may be a negative electrode which has no negative active material during the assembly of a battery but in which a lithium metal and the like are precipitated during the charge of the battery and serve as a negative active material.

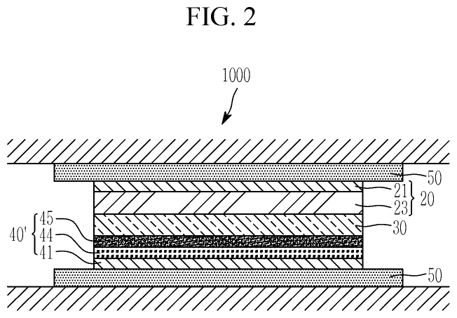

FIG. 2 shows a cross-sectional view of an all-solid-state battery including a precipitation-type negative electrode according to one or more embodiments.

Referring to FIG. 2, the precipitation-type negative electrode 40′ may include a current collecting layer 41 and a negative electrode coating layer 45 disposed or placed on the current collecting layer 41. The all-solid-state battery having the precipitation-type negative electrode 40′ may start to be initially charged in the absence of a negative active material, and a lithium metal with high density may be precipitated between the current collecting layer 41 and the negative electrode coating layer 45 during the charge to thus form a lithium metal layer 44, which may work as the negative active material. Accordingly, regarding the all-solid-state battery charged at least once, the precipitation-type negative electrode 40′ may include a current collecting layer 41, a lithium metal layer 44 disposed or placed on the current collecting layer 41, and a negative electrode coating layer 45 disposed or placed on the metal layer. The lithium metal layer 44 may represent a layer in which the lithium metal and the like are precipitated during the charge of the battery, and may be referred to as a metal layer or a negative active material layer.

The negative electrode coating layer 45 may include a metal, a carbon material, or a combination thereof functioning as a catalyst.

The metal may include, for example, gold, platinum, palladium, silicon silver, aluminum, bismuth, tin, zinc, or a combination thereof and may be composed of one selected therefrom or an alloy of more than one. If the metal is present in a particle form, the average particle diameter D₅₀ thereof may be less than or equal to about 4 μm, for example, 10 nm to 4 μm.

The carbon material may be, for example, crystalline carbon, amorphous carbon, or combinations thereof. The crystalline carbon may be, for example, natural graphite, artificial graphite, mesophase carbon microbeads, or combinations thereof. The amorphous carbon may be, for example, carbon black, activated carbon, acetylene black, denka black, ketjen black, or combinations thereof.

If the negative electrode coating layer 45 includes the metal and the carbon material, the metal and the carbon material may be, for example, mixed in the weight ratio of 1:10 to 2:1. The precipitation of the lithium metal may be effectively performed and characteristics of the all-solid-state battery may be improved. The negative electrode coating layer 45 may include, for example, a carbon material on which a catalyst metal is supported or may include a mixture of metal particles and carbon material particles.

The negative electrode coating layer 45 may include, for example, the metal and amorphous carbon, and the precipitation of the lithium metal may be effectively performed.

The negative electrode coating layer 45 may further include a binder, and the binder may be a conductive binder. The negative electrode coating layer 45 may further include general additives such as a filler, a dispersant, and an ion conductive agent.

The thickness of the negative electrode coating layer 45 may be, for example, 100 nm to 20 μm, 500 nm to 10 μm, or 1 μm to 5 μm.

The precipitation-type negative electrode 40′ may further include a thin film, for example, on a surface of the current collecting layer 41, that is, between the current collecting layer 41 and the negative electrode coating layer 45. The thin film may include an element for forming an alloy with lithium. The element for forming an alloy with lithium may be, for example, gold, silver, zinc, tin, indium, silicon, aluminum, bismuth, and the like, and may be configured with one of them or may be configured with many types of alloys. The thin film may further planarize the precipitation shape of the lithium metal layer 44 and may further improve the characteristics of the all-solid-state battery. The thin film may be formed by, for example, a vacuum deposition method, a sputtering method, a plating method, etc. The thickness of the thin film may be, for example, 1 nm to 500 nm.

### Solid Electrolyte Layer

The solid electrolyte layer 30 may include a sulfide-based solid electrolyte and an oxide-based solid electrolyte. Details of the sulfide-based solid electrolyte and the oxide-based solid electrolyte have already been described.

In one or more embodiments, the solid electrolyte included in the positive electrode 20 and the solid electrolyte included in the solid electrolyte layer 30 may include the same compound or different compounds. For example, if the positive electrode 20 and the solid electrolyte layer 30 include the argyrodite-type sulfide-based solid electrolyte, overall performance of the all-solid-state rechargeable battery may be improved. For example, if the positive electrode 20 and the solid electrolyte layer 30 include the aforementioned coated solid electrolyte, the all-solid-state rechargeable battery may implement excellent initial efficiency and lifespan characteristics while implementing high capacity and high energy density.

The average particle diameter D₅₀ of the solid electrolyte included in the positive electrode 20 may be less than the average particle diameter D₅₀ of the solid electrolyte included in the solid electrolyte layer 30. In this case, overall performance may be improved by increasing the mobility of lithium ions while maximizing the energy density of the all-solid-state battery. For example, the average particle diameter D₅₀ of the solid electrolyte included in the positive electrode 20 may be 0.1 μm to 1.0 μm or 0.1 μm to 0.8 μm, and the average particle diameter D₅₀ of the solid electrolyte included in the solid electrolyte layer 30 may be 1.5 μm to 5.0 μm, 2.0 μm to 4.0 μm, or 2.5 μm to 3.5 μm. If the particle size ranges are satisfied, the energy density of the all-solid-state rechargeable battery may be maximized while the transfer of lithium ions is facilitated, so that resistance may be suppressed, and thus the overall performance of the all-solid-state rechargeable battery may be improved. In some embodiments, the average particle diameter D₅₀ of the solid electrolyte may be measured by, for example, a particle size analyzer using a laser diffraction method. In other embodiments, about twenty particles may be arbitrarily selected from a micrograph of a scanning electron microscope or the like, the particle size may be measured, a particle size distribution may be obtained, and the value of D₅₀ may be calculated.

The solid electrolyte layer may further include a binder in addition to the solid electrolyte. Styrene butadiene rubber, polytetrafluoroethylene, polyvinylidene fluoride, polyethylene, acrylate-based polymer, or combinations thereof may be used as the binder, and without being limited thereto, anything used as the binder in the field by one of ordinary skill in the art may be used. The acrylate-based polymer may be, for example, butyl acrylate, polyacrylate, polymethacrylate, or combinations thereof.

The solid electrolyte layer may be formed by adding a solid electrolyte to a binder solution, coating it on a base film, and drying the coated result. The solvent of the binder solution may be isobutyl isobutyrate, xylene, toluene, benzene, hexane, or a combination thereof. The process for forming a solid electrolyte layer is well known in the art, and a detailed description thereof will be omitted.

The thickness of the solid electrolyte layer may be, for example, 10 μm to 150 μm.

The solid electrolyte layer may further include an alkali metal salt and/or an ionic liquid and/or a conductive polymer.

The alkali metal salt may be, for example, lithium salt. The content of the lithium salt in the solid electrolyte layer may be greater than or equal to 1 M, for example, 1 M to 4 M. The lithium salt may improve ion conductivity by improving lithium-ion mobility of the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro (oxalato) borate (LiDFOB), lithium bis(trifluoro methanesulfonyl)imide, LiTFSI, LiN(SO₂CF₃)₂, lithium bis(fluorosulfonyl)imide, LiFSI, LiN(SO₂F)₂, LiCF₃SO₃, LiAsF₆, LiSbF₆, LiClO₄, or mixtures thereof.

The lithium salt may be an imide-based salt, and for example, the imide-based lithium salt may include lithium bis(trifluoro methanesulfonyl)imide, LiTFSI, LiN(SO₂CF₃)₂, lithium bis(fluorosulfonyl)imide, LiFSI, and LiN(SO₂F)₂. The lithium salt may maintain or improve ion conductivity by appropriately maintaining chemical reactivity with the ionic liquid.

The ionic liquid has a melting point below room temperature, so it is a salt or a room-temperature molten salt in a liquid state at room temperature and composed of ions.

The ionic liquid may be a compound including at least one cation selected from among a) ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, and a mixture thereof, and at least one anion selected from among b) BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may be, for example, at least one of N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl) amide.

The weight ratio of the solid electrolyte and the ionic liquid in the solid electrolyte layer may be 0.1:99.9 to 90:10, for example, 10:90 to 90:10, 20:80 to 90:10, 30:70 to 90:10, 40:60 to 90:10, or 50:50 to 90:10. The solid electrolyte layer satisfying the above ranges may maintain or improve ion conductivity by improving the electrochemical contact area with the electrode. Accordingly, the energy density, discharge capacity, rate capability, etc. of the all-solid-state battery may be improved.

The all-solid-state battery may be a unit battery with a structure of positive electrode/solid electrolyte layer/negative electrode, a bi-cell with a structure of negative electrode/solid electrolyte layer/positive electrode/solid electrolyte layer/negative electrode, or a stacking battery repeating the structure of the unit battery.

The shape of the all-solid-state battery may vary, and may be, for example, a coin type, a button type, a sheet type, a stack type, a cylindrical shape, a flat type, and the like. The all-solid-state battery may be applied to a large-sized battery used in an electric vehicle or the like. For example, the all-solid-state battery may also be used in a hybrid vehicle such as a plug-in hybrid electric vehicle (PHEV). It may be used in a field requiring a large amount of power storage, and may be used with, for example, electric bicycles or power tools.

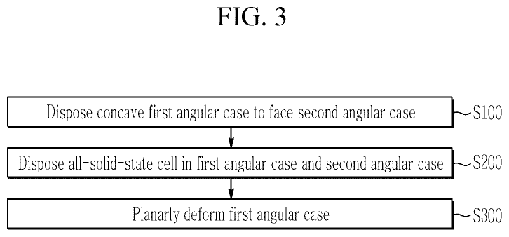

A method for manufacturing an all-solid-state rechargeable battery according to an embodiment will now be described with reference to FIG. 3 to FIG. 8.

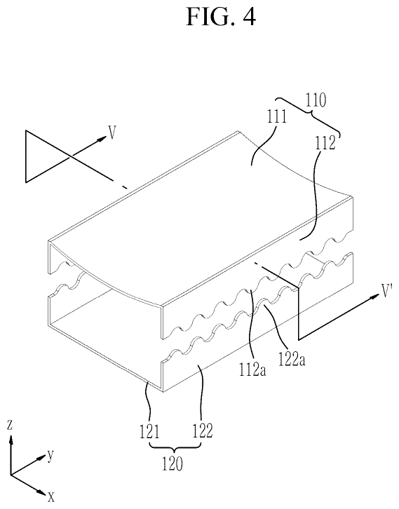

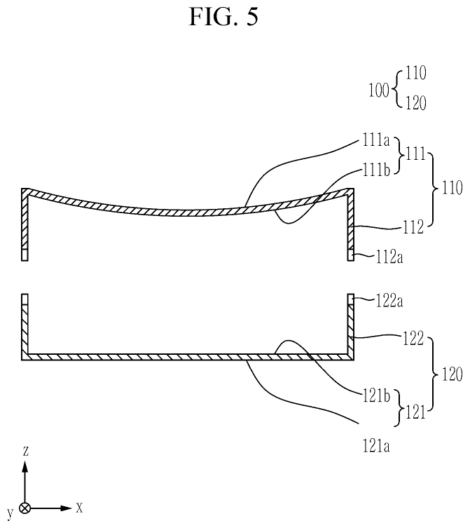

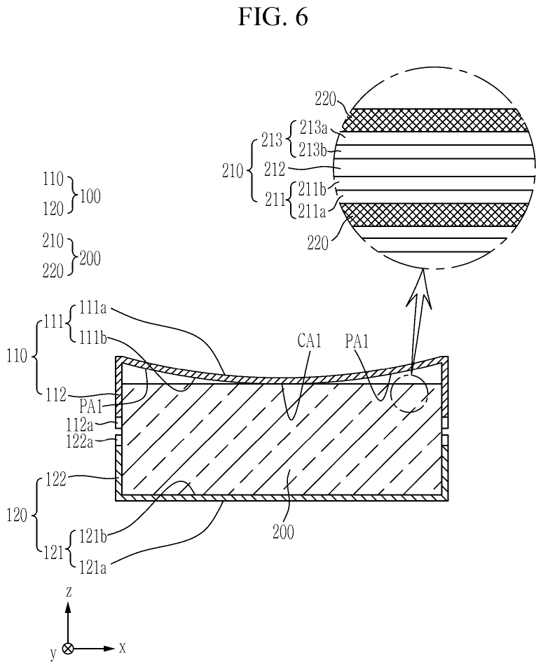

FIG. 3 shows a flowchart of a method for manufacturing an all-solid-state rechargeable battery according to one or more embodiments, FIG. 4 shows a perspective view on a first stage of a method for manufacturing an all-solid-state rechargeable battery according to one or more embodiments, FIG. 5 shows a cross-sectional view with respect to a line V-V′ of FIG. 4, and FIG. 6 to FIG. 8 show cross-sectional views on next stages of FIG. 5 according to embodiment(s).

As shown in FIG. 3 to FIG. 5, the first angular case 110 may face the second angular case 120 (S100).

The first angular case 110 and the second angular case 120 may configure an angular case 100. The first angular case 110 may include a first bottom case 111, and a first sidewall case 112 extending in the vertical direction (Z) from respective ends of the first bottom case 111. The second angular case 120 may include a second bottom case 121, and a second sidewall case 122 extending in the vertical direction (Z) from respective ends of the second bottom case 121.

The first bottom case 111 may have a first outer surface 111a that is concave downward with respect to the vertical direction (Z) and a first inner surface 111b that is convex downward with respect to the vertical direction (Z). The second bottom case 121 may have a planar second outer surface 121a and a planar second inner surface 121b.

The first inner surface 111b of the first bottom case 111 of the first angular case 110 may face the second inner surface 121b of the second bottom case 121 of the second angular case 120 and may be convex toward the second inner surface 121b.

The first sidewall case 112 of the first angular case 110 may be disposed or placed to correspond to the second sidewall case 122 of the second angular case 120.

As shown in FIG. 3 and FIG. 6, the all-solid-state cell 200 may be disposed or placed between the first angular case 110 and the second angular case 120 (S200). The second inner surface 121b of the second angular case 120 may be planar so the entire region of the second inner surface 121b of the second angular case 120 may contact a bottom surface of the all-solid-state cell 200. However, the first inner surface 111b of the first angular case 110 may be convex downward so a first center region CA1 that is a center region of the first inner surface 111b of the first angular case 110 may contact an upper surface of the all-solid-state cell 200. Therefore, a first peripheral area PA1 surrounding the first center region CA1 from among the first inner surface 111b of the first angular case 110 may not contact the upper surface of the all-solid-state cell 200.

The all-solid-state cell 200 may include unit cells 210 and elastic members 220. The unit cell 210 may include a positive electrode 211, a solid electrolyte layer 212, and a negative electrode 213. The positive electrode 211 may include a cathode, and the negative electrode 213 may include an anode. The positive electrode 211 may include a positive electrode current collecting layer 211a, and a positive active material layer 211b disposed or placed on one surface of the positive electrode current collecting layer 211a. The positive electrode current collecting layer 211a may have a plate or foil form. The positive electrode current collecting layer 211a may include one of aluminum (Al), indium (In), copper (Cu), magnesium (Mg), stainless steel (SUS), titanium (Ti), iron (Fe), cobalt (Co), nickel (Ni), zinc (Zn), germanium (Ge), and lithium (Li). The positive active material layer 211b may include one of lithium salts such as lithium nickel cobalt manganate (NCM), lithium cobalt oxide (LCO), lithium nickel oxide, lithium nickel cobalt oxide, lithium nickel cobalt aluminate (NCA), lithium manganate, or lithium iron phosphate, nickel sulfide, copper sulfide, lithium sulfide sulfur, iron oxide, or vanadium oxide.

The negative electrode 213 may include a negative electrode current collecting layer 213a, and a negative electrode coating layer 213b disposed or placed on one surface of the negative electrode current collecting layer 213a. The negative electrode current collecting layer 213a may have a plate or foil form. The negative electrode current collecting layer 213a may include various known metals and compounds that do not react to the lithium. The negative electrode current collecting layer 213a may include one of stainless steel (SUS), copper (Cu), titanium (Ti), iron (Fe), cobalt (Co), and nickel (Ni).

The negative electrode coating layer 213b may include silver (Ag) and carbon (C), but is not limited thereto. For example, the negative electrode coating layer 213b may have a structure in which a carbon layer including at least one of carbon black (CB), furnace black (FB), acetylene black (AB), Ketjen black (KB), and graphene, and may contain particles made of a metal or a semiconductor including at least one of gold (Au), platinum (Pt), palladium (Pd), silicon (Si), silver (Ag), aluminum (Al), bismuth (Bi), tin (Sn), and zinc (Zn). If charging the all-solid-state rechargeable battery, lithium may be precipitated between the negative electrode current collecting layer 213a and the negative electrode coating layer 213b so that a lithium metal layer may be formed between the negative electrode current collecting layer 213a and the negative electrode coating layer 213b, the all-solid-state rechargeable battery may be discharged, the lithium precipitated between the negative electrode current collecting layer 213a and negative electrode coating layer 213b may be removed so the negative electrode current collecting layer 213a may contact the negative electrode coating layer 213b.

The solid electrolyte layer 212 may be disposed or placed between the positive electrode 211 and the negative electrode 213. For example, the solid electrolyte layer 212 may be disposed or placed between the positive active material layer 211b and the negative electrode coating layer 213b. The solid electrolyte layer 212 may include various known sulfide-based solid electrolyte materials, but is not limited thereto. For example, the solid electrolyte layer 212 may include Li2S—P2S5, Li2S-P2S5-LiX(X is a halogen element, e.g., I or Cl), Li2S-P2S5-Li2O, Li2S-P2S5-Li2O—LiI, Li2S—SiS2, Li2S-SiS2-LiI, Li2S-SiS2-LiBr, Li2S-SiS2-LiCI, Li2S-SiS2-B2S3-LiI, Li2S-SiS2-P2S5-LiI, Li2S—B2S3, Li2S-P2S5-ZmSn (m and n are positive numbers, and Z is one of Ge, Zn, and Ga), Li2S—GeS2, Li2S-SiS2-Li3PO4, Li2S-SiS2-LipMOq (p are q are positive numbers, and M is one of P, Si, Ge, B, Al, Ga, and In). The solid electrolyte layer 212 may include at least one of amorphous and crystalline matter.

The elastic member 220 may include an elastic material such as rubber, an elastomer, or a foam.

The unit cells 210 may be stacked, and the elastic members 220 may be disposed or placed between the adjacent unit cells 210 and may be disposed or placed between the outermost unit cell 210 and the angular case 100.

In one or more embodiments shown with reference to FIG. 3, the elastic member 220 may be disposed or placed between the unit cells 210 and may be disposed or placed between the outermost unit cell 210 and the angular case 100, but is not limited thereto, and the elastic member 220 may only be disposed or placed between the outermost unit cell 210 and the angular case 100.

To minimize interface resistance of unit cell 210 including the solid electrolyte layer 212, the unit cell 210 may be maintained to be pressurized. To achieve this, the elastic member 220 installed between unit cells 210 and between the outermost unit cell 210 and the angular case 100 may provide an elastic force to the unit cell 210 and may apply a predetermined pressure to the unit cell 210.

The thickness of the all-solid-state rechargeable battery with the angular structure may be fixed as the thickness of the angular case, and the shape of the angular case may be deformed as convex by an internal pressure by the elastic member in the angular case, that is, an elastic repulsive force. However, according to some embodiments, the first angular case 110 with the concave first outer surface 111a may be manufactured, and the all-solid-state rechargeable battery may be manufactured by using the same, thereby preventing deformation of the angular case by the internal pressure and stably maintaining the performance. This will now be described in detail.

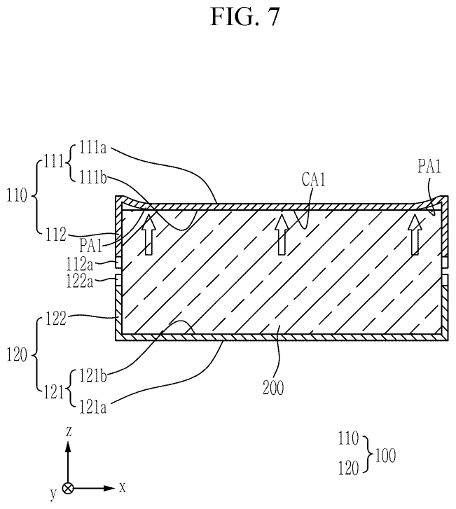

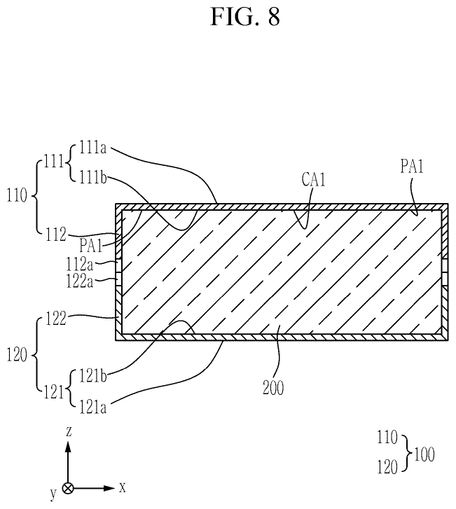

As shown in FIG. 3, FIG. 7, and FIG. 8, the first outer surface 111a of the first angular case 110 may be planarly deformed by engaging (bringing together) the first angular case 110 and the second angular case 120 (S300).

If engaging the first angular case 110 and the second angular case 120, the first lateral engagement portion 112a formed on the first sidewall case 112 of the first angular case 110 may be engaged to the second lateral engagement portion 122a formed on the second sidewall case 122 of the second angular case 120. A protrusions and depressions shape of the second lateral engagement portion 122a may be combined to a protrusions and depressions shape of the first lateral engagement portion 112a, for example, they may be welded so the first lateral engagement portion 112a and the second lateral engagement portion 122a may be engaged to each other. However, without being limited thereto, various engaging structures may be used for the first lateral engagement portion 112a and the second lateral engagement portion 122a.

As shown in FIG. 7, by engaging the first angular case 110 and the second angular case 120, the first peripheral area PA1 of the first bottom case 111 may be pulled by a tensile force of the first lateral engagement portion 112a and the second lateral engagement portion 122a, a most (or majority) portion of the first peripheral area PA1 from among the first inner surface 111b of the first bottom case 111 may contact the upper surface of the all-solid-state cell 200.

As shown in FIG. 8, the upper surface of the all-solid-state cell 200 may expand by the repulsive force of the elastic member 220 so the regions CA1 and PA1 of the first inner surface 111b of the first bottom case 111 may contact the upper surface of the all-solid-state cell 200. Hence, the first outer surface 111a and the first inner surface 111b of the first bottom case 111 may be planarly deformed, i.e., those surfaces may be pushed upward by the all-solid-state cell so as to be planar.

In the prior art, the angular case 100 expands to the outside by the repulsive force of the elastic member 220 in the angular case, and in the present embodiment, a concave deformation may be applied to the angular case 100, the all-solid-state cell 200 may be inserted into the angular case 100 so the angular case 100 may be deformed by the repulsive force of the elastic member 220 and may have a planar shape.

As described, the all-solid-state cell may be inserted into the angular case having a concave outer surface, and the outer surface of the angular case may be planarly deformed, thereby preventing the angular case from being deformed by the internal pressure in the angular case.

Hence, the pressure applied to the all-solid-state cell may be maintained, thereby stably maintaining the performance of the all-solid-state rechargeable battery.

The first angular case may have the concave first outer surface in some embodiments, and other embodiments in which the second angular case has a concave second outer surface may be possible.

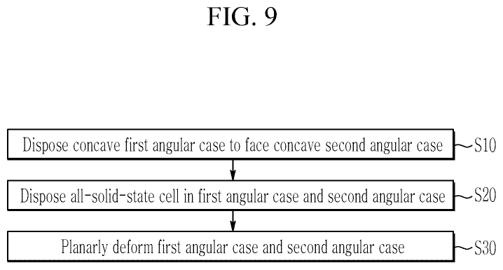

A method for manufacturing an all-solid-state rechargeable battery according to one or more embodiments will now be described with reference to FIG. 9 to FIG. 14.

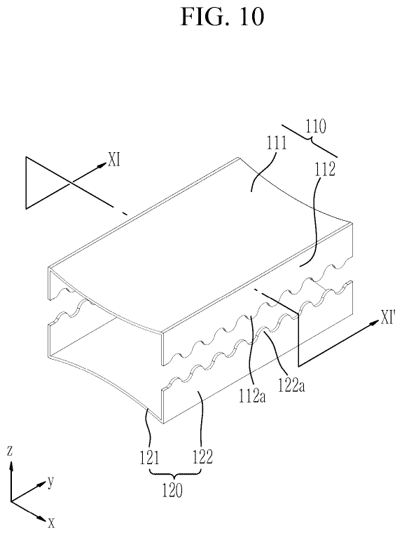

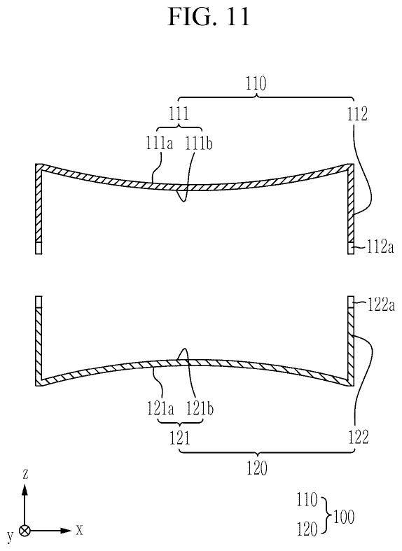

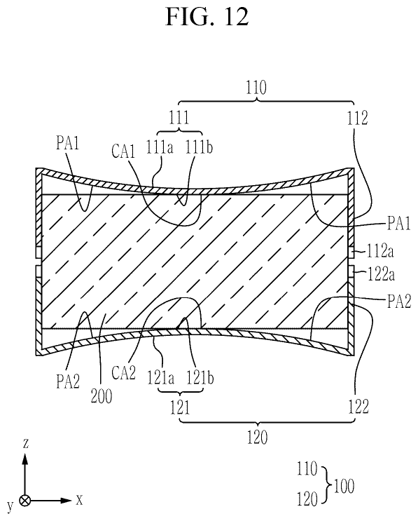

FIG. 9 shows a flowchart of a method for manufacturing an all-solid-state rechargeable battery according to one or more embodiments, FIG. 10 shows a perspective view on a first stage of a method for manufacturing an all-solid-state rechargeable battery according to one or more embodiments, FIG. 11 shows a cross-sectional view with respect to a line XI-XI′ of FIG. 10 according to one or more embodiments, and FIG. 12 to FIG. 14 show cross-sectional views on next stages of FIG. 11 according to one or more embodiments.

FIG. 9 to FIG. 14 may mostly correspond to the embodiment(s) shown in FIG. 3 to FIG. 8 excluding the second angular case so no repeated descriptions will be provided.

As shown in FIG. 9 to FIG. 11, the first angular case 110 with the concave first outer surface 111a may be disposed or placed to face the second angular case 120 with the concave second outer surface 121a (S10).

The first bottom case 111 may have a first outer surface 111a concave downward with respect to the vertical direction (Z) and a first inner surface 111b convex downward with respect to the vertical direction (Z). The second bottom case 121 may have a second outer surface 121a concave upward with respect to the vertical direction (Z) and a second inner surface 121b convex upward with respect to the vertical direction (Z).

The first inner surface 111b of the first bottom case 111 may face the second inner surface 121b of the second bottom case 121 and may be convex toward the second inner surface 121b, and the second inner surface 121b may be convex toward the first inner surface 111b.

As shown in FIG. 9 and FIG. 12 according to one or more embodiments, the all-solid-state cell 200 may be disposed or placed between the first angular case 110 and the second angular case 120 (S20).

The first inner surface 111b of the first angular case 110 may protrude to be convex downward so the first center region CA1 of the first inner surface 111b may contact the upper surface of the all-solid-state cell 200. Hence, the first peripheral area PA1 from among the first inner surface 111b of the first angular case 110 may not contact the upper surface of the all-solid-state cell 200.

The second inner surface 121b of the second angular case 120 may protrude to be convex downward so the second center region CA2 that is the center region of the second inner surface 121b may contact the bottom surface of the all-solid-state cell 200. Therefore, the second peripheral area PA2 surrounding the second center region CA2 from among the second inner surface 121b of the second angular case 120 may not contact the bottom surface of the all-solid-state cell 200.

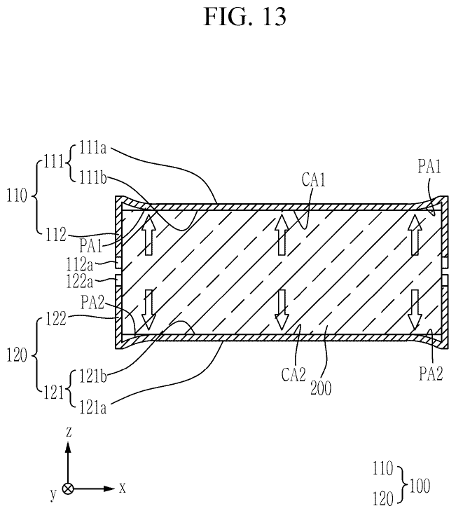

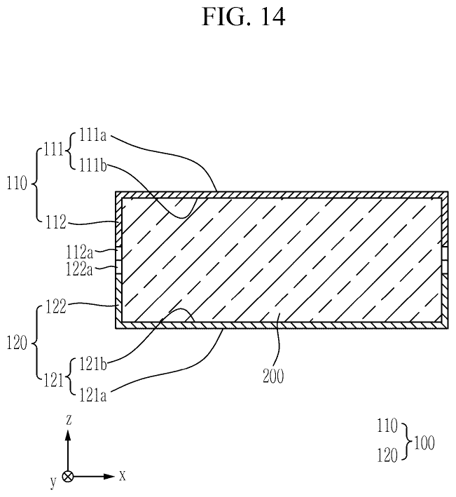

As shown in FIG. 9, FIG. 13, and FIG. 14, the first outer surface 111a of the first angular case 110 and the second outer surface 121a of the second angular case 120 may be planarly deformed by engaging the first angular case 110 and the second angular case 120 (S30).

As shown in FIG. 13, the first peripheral area PA1 of the first bottom case 111 may be pulled by the tensile force of the first lateral engagement portion 112a and the second lateral engagement portion 122a by engaging the first angular case 110 and the second angular case 120, and a most portion of the first peripheral area PA1 from among the first inner surface 111b of the first bottom case 111 may contact the upper surface of the all-solid-state battery cell 200. The second peripheral area PA2 of the second bottom case 121 may be pulled, and a most (majority) portion of the second peripheral area PA2 from among the second inner surface 121b of the second bottom case 121 may contact the bottom surface of the all-solid-state cell 200.

As shown in FIG. 14, the upper surface of the all-solid-state battery cell 200 may expand by the repulsive force of the elastic member 220, and the regions CA1 and PA1 of the first inner surface 111b of the first bottom case 111 may contact the upper surface of the all-solid-state cell 200. Therefore, the first outer surface 111a and the first inner surface 111b of the first bottom case 111 may be planarly deformed.

The bottom surface of the all-solid-state cell 200 may expand by the repulsive force of the elastic member 220, and the regions CA2 and PA2 of the second inner surface 121b of the second bottom case 121 may contact the bottom surface of the all-solid-state cell 200. Hence, the second outer surface 121a and the second inner surface 121b of the second bottom case 121 may be planarly deformed.

As described, the second angular case in addition to the first angular case may have the concave second outer surface, thereby more efficiently preventing the deformation of the angular case by the internal pressure inside the angular case.

The present disclosure provides a method for manufacturing an all-solid-state rechargeable battery for stably maintaining performance by preventing deformation of a shape of an angular case by an internal pressure.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

<Description of symbols>

| | |
|---|---|
| 100: angular case | 110: first angular case |
| 111: first bottom case | 112: first sidewall case |
| 120: second angular case | 121: second bottom case |
| 122: second sidewall case | 200: all-solid-state cell |
| 210: unit cell | 220: elastic member |

What is claimed is:

1. A method for manufacturing an all-solid-state rechargeable battery, the method comprising:
placing a first angular case with a concave first outer surface to face a second angular case;
placing a rechargeable all-solid-state battery cell including a positive electrode, a solid electrolyte layer, a negative electrode, and at least one elastic member between the first angular case and the second angular case; and
planarly deforming the first outer surface of the first angular case by engaging the first angular case and the second angular case.

2. The method as claimed in claim 1, wherein placing the first angular case to face the second angular case includes allowing a first inner surface of the first angular case to face a second inner surface of the second angular case and to be convex toward the second inner surface.

3. The method as claimed in claim 2, wherein:
the first angular case includes a first bottom case, and a first sidewall case extending in a vertical direction from respective ends of the first bottom case,
the second angular case includes a second bottom case, and a second sidewall case extending in the vertical direction from respective ends of the second bottom case, and
a first inner surface of the first bottom case faces a second inner surface of the second bottom case.

4. The method as claimed in claim 3, wherein placing the all-solid-state battery cell between the first angular case and the second angular case includes allowing a first center region of the first inner surface of the first bottom case to contact an upper surface of the all-solid-state battery cell.

5. The method as claimed in claim 4, wherein placing the all-solid-state battery cell between the first angular case and the second angular case includes allowing a first peripheral area surrounding the first center region from among the first inner surface to not contact the upper surface of the all-solid-state battery cell.

6. The method as claimed in claim 3, wherein planarly deforming the first outer surface of the first angular case includes engaging a first lateral engagement portion of the first sidewall case and a second lateral engagement portion of the second sidewall case.

7. The method as claimed in claim 6, wherein a protrusions and depressions shape of the first lateral engagement portion is engaged to a protrusions and depressions shape of the second lateral engagement portion.

8. The method as claimed in claim 7, wherein the first lateral engagement portion and the second lateral engagement portion are welded together.

9. The method as claimed in claim 3, wherein planarly deforming the first outer surface of the first angular case includes allowing the first inner surface of the first angular case to contact an upper surface of the all-solid-state battery cell.

10. The method as claimed in claim 3, wherein placing the first angular case to face the second angular case includes allowing the second bottom case of the second angular case to have a planar second outer surface.

11. The method as claimed in claim 3, wherein placing the first angular case to face the second angular case includes allowing the second bottom case of the second angular case to have a concave second outer surface.

12. The method as claimed in claim 11, wherein placing the first angular case to face the second angular case includes allowing the second inner surface of the second bottom case to face the first inner surface of the first bottom case and to be convex toward the first inner surface.

13. The method as claimed in claim 11, wherein placing the all-solid-state battery cell between the first angular case and the second angular case includes allowing a second center region of the second inner surface to contact a bottom surface of the all-solid-state battery cell.

14. The method as claimed in claim 13, wherein placing the all-solid-state battery cell between the first angular case and the second angular case includes allowing a second peripheral area surrounding the second center region from among the second inner surface to not contact the bottom surface of the all-solid-state battery cell.

15. The method as claimed in claim 11, wherein planarly deforming the first outer surface of the first bottom case includes planarly deforming a second outer surface of the second bottom case.

16. The method as claimed in claim 15, wherein planarly deforming the second outer surface of the second bottom case includes allowing the second inner surface of the second bottom case to contact a bottom surface of the all-solid-state battery cell.
